(19) United States
(12) Patent Application Publication
(10) Pub. No.: US 2008/0179522 A1
(43) Pub. Date: Jul. 31, 2008

(54) HAND-HELD METAL DETECTOR

(75) Inventors: Gerhard VALLON, Eningen (DE); Joachim BRUCKSCH, Kusterdingen (DE)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(73) Assignee: VALLON GMBH, Eningen (DE)

(21) Appl. No.: 11/875,566

(22) Filed: Oct. 19, 2007

(30) Foreign Application Priority Data
Dec. 13, 2006 (DE) 20 2006 018 938.6
Sep. 24, 2007 (EP) 07 018 683.8

(51) Int. Cl. G01T 1/167; G01V 3/11

(52) U.S. Cl. 250/336.1; 324/326

(57) ABSTRACT

A hand-held metal detector for checking persons with a probe section serving for housing a metal detection probe implemented as a detector coil, followed by a shaft serving as a handle that holds display elements and operating elements as well as metal detection electronics. In addition to the metal detection probe, the hand-held metal detector is equipped with a radiation detection probe with associated radiation detection electronics, with the radiation detection probe preferably formed by a scintillation detector. The metal and the radiation detection electronics are coupled with a differentiated signaling and alarm system.

### CROSS-REFERENCE TO RELATED APPLICATION

This application claims priority under 35 USC §119 to German Application Number 20 2006 018 938.6, filed Dec. 13, 2006, and to European Application Number 07 018 683.8, filed Sep. 24, 2007, the entire disclosures of which are incorporated herein by reference.

### BACKGROUND OF THE INVENTION

The present invention relates to a hand-held metal detector for checking persons with a ring, rod, or disk-shaped probe section serving for housing a metal detection probe designed as a detector coil, followed by a shaft serving as a handle that holds display and operating elements as well as metal detection electronics.

Such hand-held metal detectors are known per se and are available in a multitude of designs. As an example, reference can be made to DE 20 2004 006 336 U1. Hand-held metal detectors of the type referred to above are conventionally used to scan people at airports, for example. These metal detectors make it possible to locate metallic objects carried by travelers, and of special interest are those that may be used for threatening people and/or are suitable for manipulating certain installations. Apart from dangerous firearms, knives, and explosive objects that may be detected in this manner, danger may also come from radioactive substances that can only be detected by a radiation detection probe. However, excluding this danger usually requires subjecting people to an additional scan by means of a radiation detector for ionizing radiation held close to the body of the person to be checked because the radioactive radiation often has only a low intensity and/or a short range. This additional step in the process, however, is a nuisance for the travelers as well as for the security personnel and is rarely performed. In this respect, it would be desirable to perform the detection of metallic objects and of radioactive radiation as a single step.

### SUMMARY OF THE INVENTION

The present invention is a hand-held metal detector that addresses the problem of proposing a hand-held metal detector for scanning people that makes it possible to detect metallic materials and/or radioactive metallic and/or radioactive non-metallic materials, either collectively or individually.

In addition to a metal detection probe, the hand-held metal detector proposed by the invention also comprises at least one radiation detection probe. The radiation detection probe for detecting ionizing radiation is located in the vicinity of a ring, rod, or disk-shaped probe section serving to hold a detector coil of the metal detection probe, preferably next to a shaft for holding display and operating elements and/or metal detection electronics for the metal detection probe.

Together, the two probes make it possible to locate metallic objects and to detect radioactive radiation during a single non-contact scan. In order to check people, the hand-held metal detector—like known hand-held metal detectors—is passed at a close distance over the body of the person to be checked. Detected metallic and/or radioactive materials are signaled acoustically and/or visually to the security person. In order to detect radioactivity, it is possible in principle to use all types of known radiation detection probes for example Geiger tubes or scintillation detectors in conjunction with known radiation detection electronics. Of special interest are those with high sensitivity for radioactive radiation, e.g. alpha, beta, gamma, x-ray, or neutron radiation, so that the hand-held metal detector can also be used as a contamination detector for weakly radioactive traces. Due to their small size and high sensitivity, so-called scintillation detectors of the Csl or Na type, for example, are especially well suited for detecting alpha, beta, and gamma radiation. Compared with Na scintillation detectors, Csl scintillation detectors have the advantage that they are not moisture-sensitive. However, such scintillation detectors are not suitable for detecting neutron radiation so that an additional special neutron detector must be provided.

Preferably, at least one radiation detection probe is installed in such a way relative to the plane spanned by the detector coil that its maximum sensitivity for ionizing radiation is perpendicular to the detector coil. As a result, the cone of highest sensitivity of both the metal detection probe and the radiation detection probe(s) points in the same direction, i.e. the usual scanning direction of hand-held metal detectors, so that the hand-held metal detector does not need to be specially oriented in order to detect radiation. As a consequence, the hand-held metal detector according to the invention can be manipulated in familiar fashion by the security personnel, thereby ensuring a reliable scanning process for detecting metallic and/or radioactive materials.

In another preferred embodiment of the hand-held metal detector proposed by the invention, the radiation detection probe formed by a Csl scintillation detector that is preferably integrated in the shaft at the transition point to the probe section. However, in principle, the radiation detection probe can also be installed in any other suitable location of the hand-held metal detector. It may extend completely outside the probe section of the metal detection probe, or may protrude into the same. This ensures that the hand of the security person guiding the hand-held metal detector during the scanning process does not cover the collection port of the radiation detection probe. In addition, this has the effect that during the scanning process the radiation detection probe passes as close to the body of the person to be checked as the metal detection probe so that radioactive materials are detected as reliably as metallic substances.

In addition, there are advantages if the radiation detection electronics for the detected radiation as well as a display element for the intensity of the radiation are disposed in the shaft designed as a handle. The radiation detection electronics may be used in addition to the metal detection electronics. However, it is also possible to provide a central electronic detection system for both. Especially well suited as display elements for radiation are LED chains or also a LCD display that represents the intensity of the radiation as a bar.

In a preferred embodiment of the invention, detected materials trigger an acoustic and/or visual and/or haptic alarm, with the alarm signal varying in relation to the mass and/or distance and/or type of the material. For example, depending on the type of the signal, the alarm signal may differ by the brightness and/or blinking frequency of a light signal, the volume and/or by the frequency of a transmitted acoustic signal, or the intensity of a vibration signal.

It proved to be expedient to evaluate the measuring signals of the metal detection probe and of the radiation detection probe separately by means of the detection electronics, and to trigger the acoustic and/or visual and/or haptic alarm with a differentiated signaling system. Preferably, the acoustic, visual or haptic alarm changes its intensity with a proportional rise relative to the mass and/or distance and/or type of the detected substance.

In one embodiment of the invention, the metal detection probe and the radiation detection probe can be operated jointly or independent of each other.

### BRIEF DESCRIPTION OF THE DRAWINGS

Below, the invention is described in detail with reference to two embodiment examples shown in the drawing. Additional characteristics of the invention are explained in the following description of the embodiment examples of the invention in conjunction with the Claims and the attached drawing. In different implementations of the invention, the individual characteristics may be realized individually or in combinations of several.

FIG. 1 shows a schematic view of a first hand-held metal detector as proposed by the invention with a ring-shaped probe part with a Geiger tube;

FIG. 2 shows a schematic view of a second hand-held metal detector as proposed by the invention with a ring-shaped probe-part with a Csl scintillation detector; and

FIG. 3 shows a block wiring diagram of the detection electronics of the metal and the radiation detection probe.

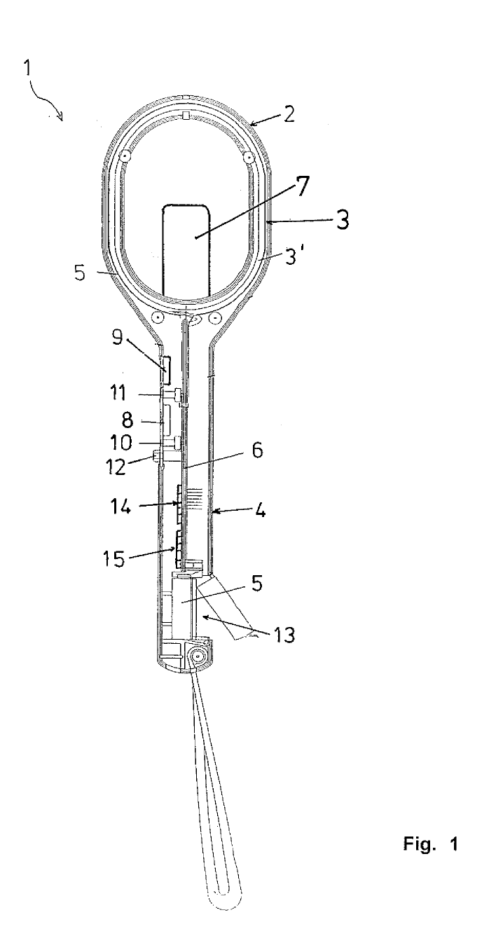

The first embodiment example of the hand-held metal detector 1 proposed by the invention, shown in a top view in FIG. 1, comprises a metal detection probe 3 and a radiation detection probe 7. The metal detection probe 3 with a detector coil 3′ is located in a ring-shaped probe section 2. At a transition point of the probe part 2 to a shaft 4, a Geiger tube is installed as radiation detection probe 7 whose collection port protrudes into that portion of the ring-shaped probe section 2 that is bordered by the detector coil 3′. The collection port is oriented relative to the plane spanned by the detector coil 3′ in such a way that the maximum sensitivity of the radiation detection probe 7 for arriving ionizing radiation is perpendicular to the detector coil 3′. For this purpose, one axis of the preferably cylindrical radiation detection probe 7 is parallel to the detector coil 3′, with the radiation detection probe 7 extending from the shaft 4 all the way to the center of the ring-shaped probe section 2. The shaft 4 following the probe section 2 is implemented as a handle and holds the other elements needed for the hand-held metal detector to function, for example the metal and radiation detection electronics 14, 15 (shown only as indications in the Fig.) and the power source 5. The detection electronics 14, 15 are located on an electric circuit board 6 to which the metal detection probe 3 and the radiation detection probe 7 are connected with wires (not shown). As operating elements, the Figure shows a light display 8 for the metal detection probe 3 and a bar display 9 for the radiation detection probe 7, two sensitivity selectors 10, 11 for the above detection probes 3, 7, and an operating mode switch 12. As power source, batteries or rechargeable batteries connected with the circuit board 6 are located in an appropriate compartment 13 of the shaft 4.

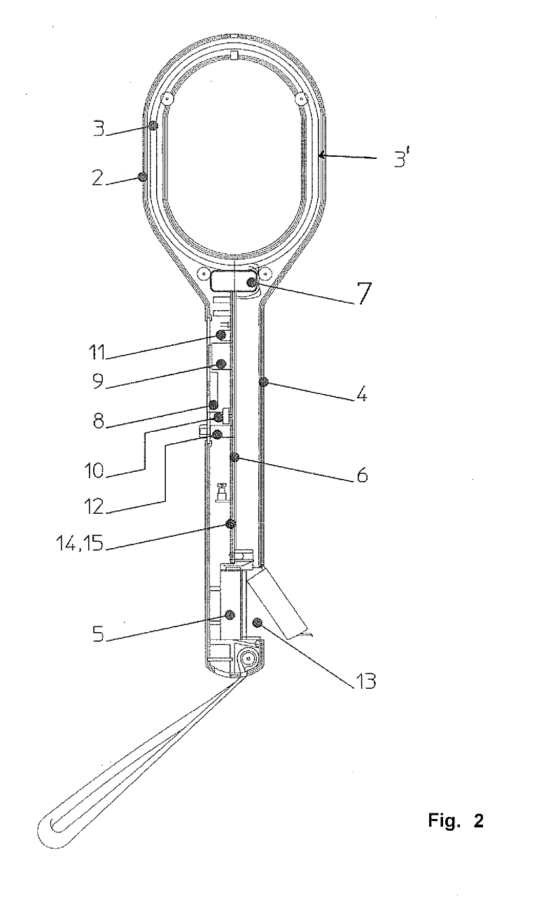

The second embodiment example of the hand-held metal detector 1 proposed by the invention, shown also in a top view in FIG. 2, is of almost identical structure as the first embodiment example shown in FIG. 1. Here, instead of a Geiger tube, a Csl scintillation detector acts as radiation detection probe 7. Due to the smaller size of the scintillation detector, the radiation detection probe 7 is completely integrated in the shaft 4 at the transition point to the probe section 2. It does not protrude into that region or portion of the ring-shaped probe section 2 that is bordered by the detector coil 3′.

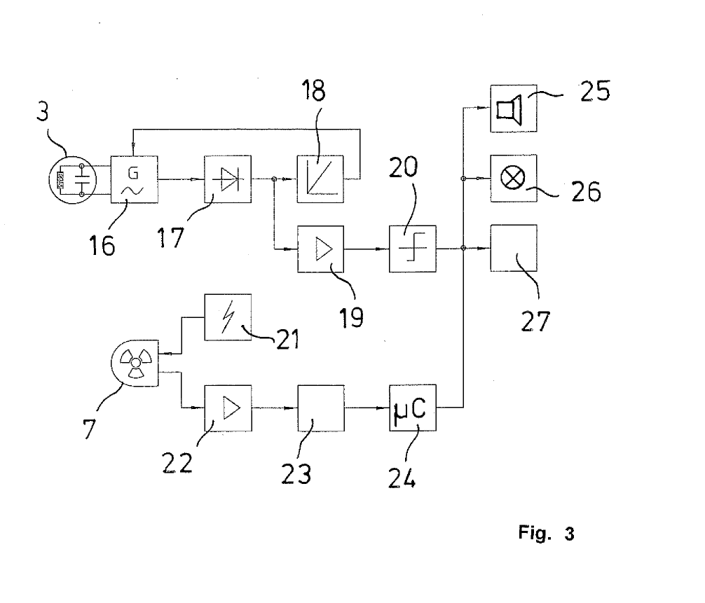

FIG. 3 shows a block wiring diagram of the detection electronics 14, 15 of the metal detection probe 3 and of the radiation detection probe 7. The detection electronics 14, 15 evaluate the signals of the metal detection probe 3 and of the radiation detection probe 7 independently. For this purpose, the metal detection electronics comprise, in sequence, an oscillator 16, a rectifier 17, and integrator 18 for signal processing, and an amplifier 19 followed by a comparator 20 for the signal evaluation, and the radiation detection electronics 15 have a pre-amplifier 22 followed by a discriminator 23 and a micro-controller 24. In addition, a high-voltage generator 21 is provided for operating the radiation detection probe 7. The comparator 20 and the micro-controller 24 are coupled with an acoustic alarm generator 25, a visual alarm generator 26, and a vibration alarm generator 27. The audio signal of the radiation electronics 15 [functions] in marked difference from the sound signal of the metal detection electronics 14, for example by chopping the audio signal of the metal detector or as an extra pulsating tone with the same or different frequency. The audio signal of the metal detection electronics 14 rises proportionally with the mass and the distance of the detected metallic substance. In the same manner, the brightness of the LED display 8 is controlled in the visual alarm mode of the metal detection electronics. The vibration alarm is triggered in addition to the visual alarm.

Although the invention has been shown and described with respect to certain embodiments, it is obvious that equivalents and modifications will occur to others skilled in the art upon the reading and understanding of the specification. The present invention includes all such equivalents and modifications, and is limited only by the scope of the following claims.

1. A hand-held metal detector for checking persons with a ring, rod, or disk-shaped probe section serving for housing a metal detection probe designed as a detector coil, followed by a shaft serving as a handle that holds display elements and operating elements as well as metal detection electronics, wherein at least one radiation detection probe for detecting ionizing radiation is located in the probe section.

2. A hand-held metal detector according to claim 1, wherein the radiation detection probe is installed in such a way relative to the plane spanned by the detector coil of the metal detection probe that its maximum sensitivity is perpendicular to the detector coil.

3. A hand-held metal detector according to claim 1, wherein the radiation detection probe is formed by a scintillation detector that is preferably integrated in the shaft at the transition to the probe section.

4. A hand-held metal detector according to claim 1, wherein radiation detection electronics for the detected radiation with a sensitivity selector and a display element for the intensity of the radiation are installed in the shaft.

5. A hand-held metal detector according to claim 1, wherein detected materials trigger an acoustic and/or visual and/or haptic alarm, with the triggered alarm signal varying depending on the mass and/or the distance and/or the type of the material.

6. A hand-held metal detector according to wherein the detection electronics evaluate the measuring signals of the metal detection probe and of the radiation detection probe independently, and trigger an acoustic and/or visual and/or haptic alarm by means of a differentiated alarm system.

7. A hand-held metal detector according to claim 1, wherein the metal detection probe and the radiation detection probe can be operated jointly or independently.
